(19) United States
(12) Patent Application Publication
(10) Pub. No.: US 2024/0239448 A1
(43) Pub. Date: Jul. 18, 2024

(54) SURFING DEVICE

(71) Applicant: Ben PLAYER, Newport (AU)

(72) Inventor: Ben PLAYER, Newport (AU)

(21) Appl. No.: 18/274,443

(22) PCT Filed: Jan. 27, 2022
(86) PCT No.: PCT/AU2022/050038

§ 371 Date: Jul. 26, 2023

(30) Foreign Application Priority Data
Jan. 27, 2021 (AU) 2021900168
Aug. 24, 2021 (AU) 2021106941

(51) Int. Cl. B63B 32/57; B29C 44/08; B29C 44/12; B29C 44/56; B29K 23/00; B29K 105/04; B29K 105/26; B29L 31/52; B63B 32/40; B63B 32/59

(52) U.S. Cl. CPC B63B 32/57; B29C 44/08; B29C 44/1271; B29C 44/569; B63B 32/40; B63B 32/59; B29K 2023/00; B29K 2105/048; B29K 2105/26; B29K 2995/0021; B29L 2031/5272

(57) ABSTRACT

The present invention relates to, in a first aspect, a surfing device including a surfing device body comprised of polymer bead foam being substantially formed from at least one polymer selected from a single polymer class, and at least one at least one performance enhancing component at least partially embedded within, or integral with, the surfing device body, the at least one performance enhancing component being substantially formed from polymers selected from the single polymer class. Further aspects of the invention, directed to a performance enhancing component and to a method of forming a surfing device body, are also disclosed.

### PRIORITY DETAILS

The present application claims priority from AU 2021900168, filed in Australia on 27 Jan. 2021, and AU 2021106941, filed in Australia on 24 Aug. 2021, the entirety of which is incorporated herein by reference.

### TECHNICAL FIELD

The present invention relates generally to the field of surfing devices, and more particularly to the field of forming recyclable surfing device bodies out of polymers.

### BACKGROUND

In the last few years, surfing devices comprised of plastic have increased in consumer demand and usage. They come in many shapes and sizes and are commonly known as Boogie Boards, Body Boards, Soft Surf Boards, Foam Surf Boards, Softies and Foamies, and can be ridden in multiple ways, such as laying on, kneeling on or standing on.

A few variations for surfing devices comprised of polymers exist, and are well documented as prior art, but all prior art surfing devices share the negative aspects of being unable to be conveniently recycled as a result of being comprised of multiple plastic types, aesthetic limitations as a result of materials available, or lack of performance as a result of manufacturing limitations.

As the skilled person will appreciate, plastics or polymers of different types, classes or categories are recycled in different manners, and so a prior art surfing device comprised of polymers selected from a plurality of different polymer classes requires additional processing so as to separate plastics by type, category or class. Furthermore, certain plastic or polymer types are unable to be easily recycled—for example, the majority of thermoset plastics can only be readily ‘downcycled’ by being ground into fibres which can be used as filler or downstream material, but cannot be melted down and re-moulded.

The present invention seeks to provide a surfing device having improvements to strength, durability, functionality, aesthetics and performance. The present invention additionally seeks to alleviate, reduce or overcome deficiencies and problems in the prior art.

### DISCLOSURE OF THE INVENTION

In a first aspect, the present invention relates to a surfing device including a surfing device body comprised of polymer bead foam being substantially formed from polymer foam beads of at least one polymer selected from a single polymer class, and at least one performance enhancing component at least partially embedded within, or integral with, the surfing device body, the at least one performance enhancing component being substantially formed from polymers selected from the single polymer class.

In an embodiment, the at least one performance enhancing component is moulded from the polymers selected from the single polymer class.

In an embodiment, the at least one performance enhancing component is selected from the list of pre-moulded peripheral skin, leash anchor, strengthening element, strengthening element mount, fin mount, and fin, and the at least one performance enhancing component is in a solid and non-foamed state and is affixed to the surfing device body by being at least partially embedded within.

In an embodiment, the at least one performance enhancing component is a peripheral skin region, being an outer region of the polymer bead foam of the surfing device body having a denser bead morphology than an inner region of the surfing device body, the peripheral skin is formed from, and integral with, the polymer bead foam of the surfing device body, and the peripheral skin region forms a stressed shell structure, such that the surfing device body and integral peripheral skin region thereof is a semi-monocoque.

In an embodiment, the at least one performance enhancing component is permanently embedded into or integral with the surfing device body.

In an embodiment, an embedded portion of the at least one performance enhancing component is directly bonded with the polymer bead foam of the surfing device body substantially adjacent thereto.

In an embodiment, the surfing device may further comprise at least one surface-affixed performance enhancing component mounted to an outer surface of the surfing device body, the at least one surface-affixed performance enhancing component being a moulded performance enhancing component that is substantially formed from polymers selected from the single polymer class in a solid and non-foamed state, wherein a contacting portion of the at least one surface-affixed performance enhancing component is directly bonded with the polymer bead foam of the outer surface.

In an embodiment, the surfing device does not comprise additional affixing means between the surfing device body and the at least one performance enhancing component.

In an embodiment, the single polymer class is one of the set of classes comprising thermoplastics, recyclable thermosets, polypropylenes, polyketones, or polyolefins.

In an embodiment, the polymer bead foam is substantially formed from a single polymer. In an embodiment, the at least one performance enhancing component is substantially formed from the same single polymer as the polymer bead foam of the surfing device body. In a further embodiment, the single polymer is selected from the list of polypropylene, polyethylene, polystyrene and polyurethane.

In an embodiment, the polymer bead foam is substantially formed from a first blend of polymers, each polymer in the first blend of polymers being selected from the same polymer class, and the at least one performance enhancing component is substantially formed from a second blend of polymers, being a blend of the same selection of polymers as the first blend of polymers. In a further embodiment, the second blend of polymers comprises the same selection of polymers, in a substantially similar compositional ratio, as the first blend of polymers. In a further embodiment, the first blend of polymers is a blend of polyolefins.

In an embodiment, the surfing device body is formed through discrete unit moulding.

In an embodiment, the polymer bead foam is formed from foamable polymer beads comprising a mix of colours. In an embodiment, the surfing device body further comprises at least one of a disruptive texture pattern or a textured grip pattern on at least a portion of an outer surface of the surfing device body.

In an embodiment, the surfing device body consists essentially of the polymer bead foam substantially formed from at least one polymer selected from the single polymer class. In an embodiment, the surfing device consists essentially of at least one polymer selected from the single polymer class.

A second aspect of the invention may lie in a performance enhancing component for a surfing device including a surfing device body comprised of polymer bead foam formed from at least one polymer selected from a single polymer class, the performance enhancing component comprising an embedding portion, wherein the performance enhancing component is substantially comprised of at least one polymer selected from the single polymer class, and the embedding portion is configured to be embedded within the surfing device body and directly bond with the polymer bead foam of the surfing device body substantially adjacent thereto.

In an embodiment, the embedding portion comprises at least one aperture extending therethrough, such that a portion of the surfing device body extends therethrough when the performance enhancing component is embedded therein.

In an embodiment, the performance enhancing component is comprised of the at least one polymer selected from the single polymer class in a solid and non-foamed state. In an embodiment, the performance enhancing component is moulded from the at least one polymer selected from the single polymer class.

In an embodiment, the performance enhancing component may be used in formation of a surfing device of an embodiment of the first aspect of the invention.

In an embodiment, the present invention may be a surfing device including a surfing device body comprised of polymer bead foam formed from polymers selected from a single polymer class and at least one performance enhancing component of an embodiment of the second aspect of the invention, wherein the surfing device does not comprise additional affixing means between the surfing device body and the at least one performance enhancing component.

A third aspect of the invention may lie in a method of forming a surfing device body, comprising the steps of:
i. inserting foamable polymer beads into a cavity of a mould shaped to substantially form the surfing device body;
ii. inducing expansion and joining of the foamable polymer beads within the mould cavity together into a polymer bead foam moulding having the shape of the mould cavity; and
iii. ejecting the polymer bead foam moulding, having the shape of the surfing device body, from the mould cavity;
   wherein the foamable polymer beads are comprised of polymers selected from a single polymer class.

An alternate embodiment of the method may comprise the steps of:
i. inserting foamable polymer beads into a cavity of a mould shaped to form a moulded polymer bead foam blank;
ii. inducing expansion and joining of the foamable polymer beads within the mould cavity together into a moulded polymer bead foam blank having the shape of the mould cavity;
iii. ejecting the polymer bead foam moulding from the mould cavity; and
iv. shaping the polymer bead foam moulding into a shape of the surfing device body;
   wherein the foamable polymer beads are comprised of polymers selected from a single polymer class.

In an embodiment, at least a portion of an inner surface of the mould cavity comprises structures shaped to form at least one of a disruptive texture pattern and a textured grip pattern on an outer surface of the surfing device body during step (II).

In an embodiment, the method further comprises the step of inserting an embedding portion of at least one moulded performance enhancing component into the mould cavity prior to either step (1) or step (II), wherein the step of inducing expansion and joining of the foamable polymer beads also comprises the polymer bead foam substantially encapsulating the embedding portion of the moulded performance enhancing component, and the at least one moulded performance enhancing component is substantially formed from polymers selected from the single polymer class in a solid and non-foamed state. In a further embodiment, the embedding portion is configured to be embedded within the surfing device body and thermally bond with the polymer bead foam of the surfing device body substantially adjacent thereto. In a further embodiment, the at least one moulded performance enhancing component is a performance enhancing component of an embodiment of the second aspect of the invention.

In an embodiment, the method further comprises the step of affixing at least one surface-mounted moulded performance enhancing component to an outer surface of the surfing device body, wherein the at least one surface-mounted performance enhancing component is substantially formed from polymers selected from the single polymer class in a solid and non-foamed state, and the at least one surface-mounted performance enhancing component is affixed to the outer surface of the surfing device body by a contacting portion thereof thermally bonding to the outer surface of the surfing device body.

In an embodiment, the method further comprises the step of bonding the embedding or contacting portion to the surfing device body by at least partial melting of the embedding or contacting portion.

In an embodiment, wherein the step of bonding the embedding or contacting portion to the surfing device body comprises the use of any one of infra-red welding, high frequency welding and ultrasonic welding.

In an embodiment, expansion and joining of the foamable polymer beads within the mould cavity is at least partially induced by heating of the mould cavity and/or further mould cavity and/or foamable polymer beads contained therein, and a cavity wall of the mould cavity is maintained at, or reduced to, a lower temperature than that of the mould cavity for at least a portion of Step II, such that foamable polymer beads substantially adjacent to, or subsequently urged to be adjacent to, the cavity wall will expand to a lesser degree than foamable polymer beads further away from the cavity wall, forming peripheral-region polymer bead foam having a denser bead or cell morphology than the polymer bead foam ‘interior’ or ‘core’ portions, the peripheral-region polymer bead foam being integral with, and otherwise thermally bonded to, the polymer bead foam. In an embodiment, the peripheral-region polymer bead foam forms into a stressed-shell structure encapsulating the polymer bead foam, and the resulting surfing device body is a semi-monocoque.

In an embodiment, the mould cavity is shaped to fully form the surfing device body, such that the formed polymer bead foam moulding requires no further substantial shaping.

In an alternate embodiment, the method of forming a surfing device body comprises the steps of:
i. inserting foamed polymer beads into a cavity of a mould shaped to form a polymer bead foam moulding;
ii. inducing expansion and joining of the foamable polymer beads within the mould cavity together into a polymer bead foam moulding;
iii. ejecting the formed polymer bead foam moulding from the mould cavity; and
iv. if the polymer bead foam moulding is not shaped into the surfing device body, inserting the polymer bead foam moulding into a further mould cavity that is larger in at least one dimension and repeating steps (I)-(III), such that an additional polymer bead foam layer overmoulds onto, and thermally bonds to, the polymer bead foam moulding, forming a layered polymer bead foam moulding;
   wherein the foamable polymer beads are comprised of polymers selected from a single polymer class.

In an embodiment, at least a portion of an inner surface of the mould cavity or the further mould cavity comprises structures shaped to form at least one of a disruptive texture pattern and a textured grip pattern on an outer surface of the surfing device body during step (II).

In an embodiment, the method further comprises the step of inserting an embedding portion of at least one performance enhancing component into the mould cavity or further mould cavity prior to either step (1) or step (II), wherein the step of inducing expansion and joining of the foamable polymer beads also comprises the polymer bead foam substantially encapsulating the embedding portion, the at least one performance enhancing component is substantially formed from polymers selected from the single polymer class in a solid and non-foamed state, and the embedding portion is configured to be embedded within the surfing device body and thermally bond with the polymer bead foam of the surfing device body substantially adjacent thereto.

In an embodiment, the at least one performance enhancing component is a performance enhancing component of an embodiment of the second aspect of the invention.

In an embodiment, the method further comprises the step of affixing at least one surface-mounted performance enhancing component to an outer surface of the surfing device body, wherein the at least one surface-mounted performance enhancing component is substantially formed from polymers selected from the single polymer class in a solid and non-foamed state, and the at least one surface-mounted performance enhancing component is affixed to the outer surface of the surfing device body by a contacting portion thereof thermally bonding to the outer surface of the surfing device body.

In an embodiment, the method further comprises the step of bonding the embedding or contacting portion to the surfing device body by at least partial melting of the embedding or contacting portion.

In an embodiment, the step of bonding the embedding or contacting portion to the surfing device body comprises the use of any one of infra-red welding, high frequency welding and ultrasonic welding.

In an embodiment, expansion and joining of the foamable polymer beads within the mould cavity is at least partially induced by heating of the mould cavity and/or further mould cavity and/or foamable polymer beads contained therein, and a cavity wall of the mould cavity and/or further mould cavity is maintained at, or reduced to, a lower temperature than that of the mould cavity and/or further mould cavity for at least a portion of Step (II), such that foamable polymer beads substantially adjacent to, or subsequently urged to be adjacent to, the cavity wall expand to a lesser degree than foamable polymer beads further away from the cavity wall, forming peripheral-region polymer bead foam having a denser bead or cell morphology than the polymer bead foam, the peripheral-region polymer bead foam being integral with, and otherwise thermally bonded to, the polymer bead foam. In an embodiment, the peripheral-region polymer bead foam forms into a stressed-shell structure encapsulating the polymer bead foam, and the resulting surfing device body is a semi-monocoque.

A fourth aspect of the invention may lie in a method of forming a surfing device body, the method comprising the steps of:
i. inserting foamed polymer beads into a cavity of a mould;
ii. inducing expansion and joining of the foamable polymer beads within the cavity until an initial polymer bead foam moulding forms and reaches a target density and shape;
iii. ejecting the initial polymer bead foam moulding from the mould cavity;
iv. inserting the initial polymer bead foam moulding into a further mould cavity that is larger in at least one dimension;
v. inserting additional foamable polymer beads into the further mould cavity and inducing expansion and joining of the additional foamable polymer beads therewithin, such that an additional polymer bead foam layer overmoulds onto, and thermally bonds to, the initial polymer bead foam moulding, forming a resulting polymer bead foam moulding;
vi. ejecting the resulting polymer bead foam moulding comprising the initial polymer bead foam moulding overmoulded with the additional polymer bead foam layer, from the further mould cavity; and
vii. if the resulting polymer bead foam moulding is not shaped into a surfing device body of appropriate dimensions, repeating steps (IV)-(VI) with further mould cavities that are successively larger in at least one dimension, the resulting polymer bead foam moulding formed by step (VI) being the ‘initial polymer bead foam moulding’ of the subsequent step (IV);
   wherein the further mould cavity that shapes the resulting polymer bead foam moulding into the surfing device body of appropriate dimensions is the final further mould cavity, and the foamable polymer beads comprise polymers selected from a single polymer class.

In an embodiment, the method further comprises the step of inserting an embedding portion of a performance enhancing component into the mould cavity prior to step (II) or into the further mould cavity prior to step (V), the at least one performance enhancing component being substantially formed from polymers selected from the single polymer class in a solid and non-foamed state, wherein the embedding portion is configured to be embedded within the surfing device body and form thermal bonds with the polymer bead foam of the surfing device body substantially adjacent thereto.

In an embodiment, the method further comprises the step of bonding the embedding portion to the surfing device body by at least partial melting of the embedding portion. In an embodiment, the step of bonding the embedding portion to the surfing device body comprises the use of any one of infra-red welding, high frequency welding and ultrasonic welding

In an embodiment, at least a portion of an inner surface of the final further mould cavity comprises structures shaped to form at least one of a disruptive texture pattern and a textured grip pattern on an outer surface of the surfing device body during step (V).

In an embodiment, expansion and joining of the foamable polymer beads within the final further mould cavity is at least partially induced by heating of the final further mould cavity and/or foamable polymer beads contained therein, and a cavity wall of the final further mould cavity is maintained at, or reduced to, a lower temperature than that of the mould cavity for at least a portion of Step (V), such that foamable polymer beads substantially adjacent to, or subsequently urged to be adjacent to, the final further mould cavity wall expand to a lesser degree than foamable polymer beads in step (II) and/or previous iterations of Step (V), such that the formed additional polymer bead foam layer comprises peripheral-region polymer bead foam having a denser bead or cell morphology than that of the initial polymer bead foam, the peripheral-region polymer bead foam being integral with, and otherwise thermally bonded to the initial polymer bead foam moulding.

In an embodiment, the final further mould cavity is maintained at a higher temperature than that of the final cavity wall, such that the formed additional polymer layer comprises a region adjacent to the initial polymer bead foam moulding and having a foam morphology substantially similar thereto, and a peripheral region forming the peripheral-region polymer bead foam having a denser bead or cell morphology, the regions being integral with, and otherwise thermally bonded, to one another. In an embodiment, the peripheral-region polymer bead foam forms into a stressed-shell structure encapsulating the polymer bead foam, and the resulting surfing device body is a semi-monocoque.

Further aspects and/or embodiments beyond those described above may be disclosed herein. These and other embodiments are considered to fall within the scope of the invention.

### DESCRIPTION OF FIGURES

Embodiments of the present invention will now be described in relation to figures, wherein:

FIGS. 1-3 depict embodiments of a surfing device of the present invention;

FIGS. 4 & 5 depict embodiments of a performance enhancing component of the present invention; and

FIGS. 6-11 depict embodiments of a method of forming a surfing device body of the present invention.

### DETAILED DESCRIPTION OF PREFERRED EMBODIMENTS

In the following description, numerous specific details are set forth to provide a thorough understanding of the presently described embodiments. It will be apparent, however, to one skilled in the art that the presently described embodiments may be practiced without some or all of these specific details. In other instances, well known process steps have not been described in detail in order to avoid unnecessarily obscuring the presently described embodiments. These and other embodiments are discussed below with reference to the figures. However, those skilled in the art will readily appreciate that the detailed description given herein with respect to these figures is for explanatory purposes only and should not be construed as limiting. The person skilled in the art will further appreciate that the various embodiments disclosed below are not exclusive and may be combined in a single surfing device without departing from the scope of the invention.

In a first aspect, the present invention relates to a surfing device including a surfing device body comprising of polymer bead foam substantially formed from polymers selected from a single polymer class, and at least one performance enhancing component that is at least partially embedded within the surfing device body.

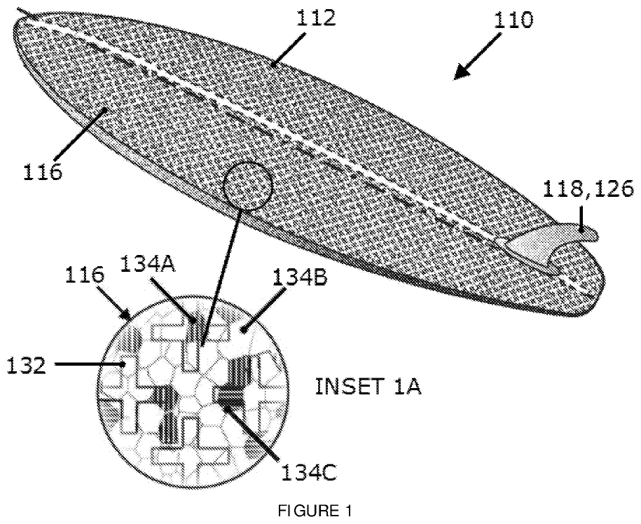

In an embodiment and with reference to FIGS. 1 to 3 and Inset 2A, the present invention may comprise a surfing device 110 having a surfing device body 112 comprised of foamable polymer beads formed of polymers selected from a single polymer class that have been expanded into ‘foamed polymer beads 114’ and joined into polymer bead foam. As depicted, the surfing device body 112 comprises expanded foamed polymer beads 114 forming both the inner ‘core’ of the body and an outer surface 116 of the body. In an embodiment, the surfing device 110 may further comprise at least one at least one performance enhancing component 118 that is at least partially embedded within, or integral with, the surfing device body 112. In an embodiment, the at least one performance enhancing component 118 may be permanently embedded into, or integral with, the surfing device body 112. In an embodiment the at least one performance enhancing component 118 is substantially formed from polymers selected from the same single polymer class as that of the surfing device body 112. In a further embodiment, the at least one performance enhancing component 118 may be moulded from the polymers selected from the single polymer class.

In an embodiment, the at least one performance enhancing component 118 may be thermally bonded to the surfing device body 112. In a further embodiment, the thermal bonds may be molecular bonds between the polymer or polymers of the at least one performance enhancing component 118 and the polymer or polymers of the foamed polymer beads 114.

It is considered that, by providing a surfing device that is at least substantially comprised of similar materials (such as polymers selected from the same polymer class), efficiency of production may be improved. Furthermore, the use of additional affixing means may be reduced or eliminated, as bonding between the components comprised of substantially similar materials may be promoted. Additionally, upon an embodiment of the surfing device 110 reaching end-of-life, the ability for and/or efficiency of the surfing device 110 to be recycled may be improved as it is not required to separate the components into a plurality of recycling streams directed to separate plastic classes, types or categories, and the single polymer class is selected from polymer classes that are able to be recycled.

In a further embodiment, the surfing device body 112 and/or the performance enhancing component 118 may consist essentially of at least one polymer selected from the single class of polymers. In a further embodiment, the surfing device 110 as a whole may consist essentially of at least one polymer selected from the single polymer class. This may further enhance or promote the ability of the surfing device body and the at least one performance enhancing component 118 to thermally bond to one another, and may also promote or enhance the recyclability of the surfing device 110 at end-of-life.

As used herein, “consist essentially” should not be strictly interpreted so as to preclude the presence of trace other materials that do not otherwise increase the complexity of recycling of a component or article in question. Rather, “consist essentially” is to be understood to mean that the component or article in question either does not comprise materials other than the identified material or materials, or said other materials are present in negligible amounts. Similarly, “negligible” is to be interpreted to mean that any other materials in the composition of the component or article in question are present in fractions too small to materially alter either the component or article in question, or its ability to be recycled at end-of-life.

Some other materials that may be present are remnants from the formation of the foamable polymer beads, such as foaming agents; dyes or other colouring agents; additives utilised to promote expansion, sintering and/or thermal bonding of the foamable polymer beads to one another and/or to an embedding or contacting portion of a performance enhancing component; trace amounts of polymers from a different polymer class; and any other trace contaminants or additives that the person skilled in the art would reasonably anticipate as being likely to be present in components or articles formed from foamable polymer beads that have been expanded and joined together into polymer bead foam without affecting the structure, functionality or recyclability of the component or article. The person skilled in the art will understand that the preceding list is not exhaustive.

In some embodiments and with reference to Inset 2B, the at least one performance enhancing component 118 may be a peripheral skin region 120 being formed from, and integral with, the polymer bead foam of the surfing device body 112. As depicted, the beads 114 of the surfing device body 112 may have a denser bead morphology in a peripheral skin region 120, growing ever denser towards the outer surface 116, compared to the interior of the surfing device. The denser peripheral skin region 120 may form a ‘shell’ around the inner portion of the surfing device body that comprises a relatively less dense bead morphology. The peripheral skin region 120 may be a stressed-shell structure, wherein the stresses within the formed peripheral skin region 120 improve the strength and rigidity of the surfing device body. In an embodiment, the surfing device body having the peripheral skin region 120 may be a semi-monocoque. In an embodiment, provision of the peripheral skin region 120 may enable a smoother surface finish with more acute angles and intricate shapes as a result of smaller bead size. In an embodiment, it may enable fewer inter-bead voids on the outer surface 116, which may improve hydrodynamic performance of the formed surfing device.

A semi-monocoque skin structure is a type of ‘stressed shell structure’ having a unique structural arrangement where a peripheral skin (with reference to Inset 2B, the peripheral skin region 120 and outer surface 116) possesses a measure of structural strength and rigidity from the stresses within said outer skin, in this case the stresses imparted by the dense bead morphology of the peripheral skin region 120. The strength and rigidity of the peripheral skin region 120 and outer surface 116 is further aided by an interior reinforcement. As such, a surfing device body 112 formed in this manner may result in the expanded foamed polymer beads 114 collectively working as a cohesive structure. A semi-monocoque skin structure may be able to react to loads and impacts as a single structure by counteracting with an opposing force, from the opposite side thereof, as the semi-monocoque skin structure cohesively tries to return to its thermally-fused shape memory. These functions may increase the performance of the surfing device 110, while reducing the amount of water that can enter the interior of the surfing device when it is being used.

In an embodiment, the surfing device does not include an additional or separate skin that is subsequently moulded onto the surfing device body 112 post moulding. In such an embodiment, the provision of a peripheral skin region 120 is considered able to provide the rigidity, water-sealing and other properties that would otherwise be provided by a separate skin.

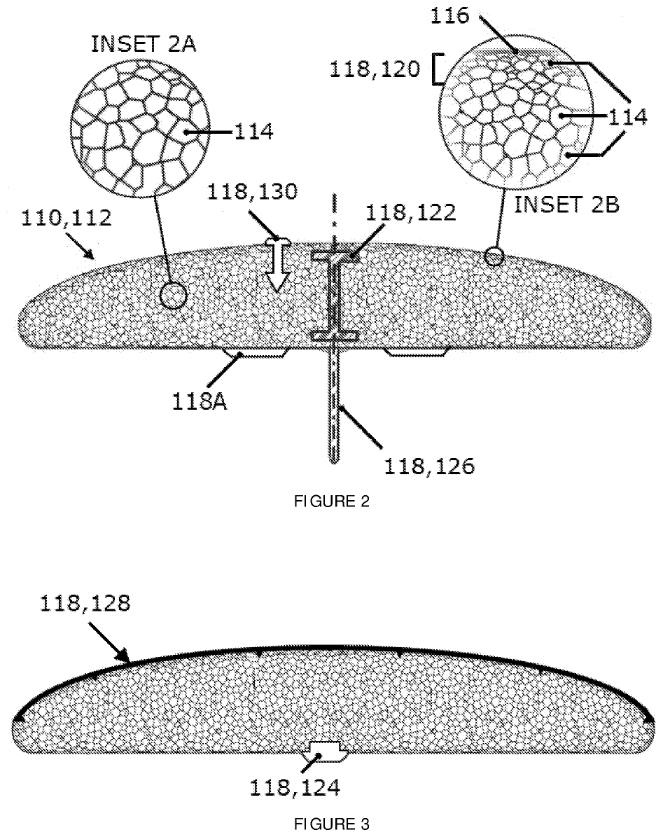

In an embodiment and with further reference to FIGS. 2 & 3, the at least one performance enhancing component 118 may be selected from the list of strengthening element 122, fin mount 124, fin 126, pre-moulded peripheral skin 128, leash anchor 130, an anchor for a strengthening element (not shown), or a gripping means (not shown). In a further embodiment, the at least one performance enhancing component 118 is in a solid and non-foamable state, such that the at least one performance enhancing component 118 is formed from polymers of the same polymer class as the polymer foam beads of the surfing device body 112, but the at least one performance enhancing component is not formed from a foam of said polymers. The person skilled in the art will appreciate that an embodiment of the performance enhancing component 118 that is in a solid and non-foamed state is typically pre-moulded.

In an embodiment wherein the at least one performance enhancing component 118 is a pre-moulded peripheral skin 128, the surfing device body 112 may be formed by expanding the polymer foam beads 114 into the polymer bead foam within or substantially against the pre-moulded peripheral skin 128. This may comprise initially moulding the peripheral skin 128, placing the pre-moulded peripheral skin into a mould cavity, inserting the polymer foam beads 114 thereinto, and expanding the polymer foam beads 114 to form the surfing device body 112 within the pre-moulded peripheral skin. In an embodiment and as depicted in FIG. 3, the pre-moulded peripheral skin 128 may be initially shaped to cover a portion of the surfing device body 112. In an alternate embodiment (not depicted), the pre-moulded peripheral skin 128 may substantially completely cover the surfing device body 112. In a further embodiment, two or more pre-moulded peripheral skins may be used to substantially completely cover the surfing device body 112.

In an embodiment, the at least one performance enhancing component may be affixed to the surfing device body 112 by being at least partially embedded within, with an embedded portion of the at least one performance enhancing component 118 thermally bonding with the polymer bead foam of the surfing device body 112 substantially adjacent thereto. In a further embodiment, the surfing device 110 does not comprise additional affixing means between the surfing device body 112 and the at least one performance enhancing component 118, such as rivets, stitching, adhesives, or other affixing means known in the art. This may enable reduction in the number of different materials present within the surfing device 110. This may improve the ability of the surfing device to be recycled at end-of-life.

In an embodiment, at least one surface-affixed performance enhancing component 118A may also be affixed to the surfing device body 112 by a contacting portion of the surface-affixed performance enhancing component 118A being thermally bonded to the outer surface 116 of the surfing device body 112. The surface-affixed performance enhancing component 118A may be a leash anchor, a fin box/fin mount, a gripping means, a pre-moulded peripheral skin, or any other performance enhancing component suitable for surface mounting. The surface-affixed performance enhancing component 118A may be substantially formed from polymers selected from the single polymer class.

In at least one further embodiment, forming the performance enhancing component 118 or surface-affixed performance enhancing component 118A from polymers selected from the same polymer class as the surfing device body 112, may promote thermal, molecular or interfacial bonding between a portion of the device body 112 contacting with an embedded portion of the performance enhancing component or surface-affixed performance enhancing component.

The skilled person will appreciate that there are many known polymers, and that they may be classified in various manners depending upon classification criteria. Polymers may, for example, be classified based upon source material (natural, synthetic or semi-synthetic); monomer chain structure (linear, cross-linked or branched-chain); polymerisation method (addition or condensation);

monomer type (homomeric or copolymeric); and present molecular forces (elastomers, fibrous, thermoplastics or thermosetting polymers). As used herein, polymer class refers to groups of polymers that are able to be recycled through the same recycling process or substantially similar recycling processes.

In an embodiment, the polymers may be selected from groups such as thermoplastics, recyclable thermoset polymers, and polyolefins. In an embodiment, the polymers may be selected from particular groups such as polyketones, polyethylenes, polyesters, polypropylenes and polyurethanes. In an embodiment, one or more of the selected polymers may be co-polymers. In an alternate embodiment, each of the selected polymers may be homomeric.

In an embodiment, the polymer bead foam may be substantially formed from a single polymer. In a further embodiment, the at least one performance enhancing component 118 may be substantially formed from the same single polymer as the polymer bead foam of the surfing device body. In a further embodiment, the single polymer may be selected from the list of polypropylene, polyethylene, polystyrene and polyurethane. In a further embodiment, the polymer may be polypropylene. An attribute of polypropylene is its ability to endure repeated flexion and extension, and return to its thermally-fused shape memory. Polypropylene also has superior intermolecular bonding capabilities compared to other expanded polyolefin bead foams, including expanded polystyrene bead foam. The combined attributes of polypropylene may provide the means of fabricating a superior surfing device 10 that functions with unique flexural properties and tensile responses to loads and impacts.

In an alternate embodiment, the polymer bead foam may be substantially formed from a first blend of polymers, each polymer in the first blend of polymers being selected from the same polymer class. In a further embodiment, the at least one performance enhancing component 118 may be substantially formed from a second blend of polymers, being a blend of the same selection of polymers as the first blend of polymers. In a further embodiment, the second blend of polymers comprises the same selection of polymers in a substantially similar compositional ratio as the first blend of polymers. In an embodiment, the first blend of polymers is a blend of polyolefins.

In an embodiment and with reference to Inset 1A of FIG. 1, at least a portion of an outer surface 116 of the surfing device body 112 may comprise a texture pattern 126 formed thereupon. In an embodiment, the texture pattern 126 may be a disruptive texture pattern configured to disrupt visibility of an outline of the expanded beads 114. Disruptive patterns, also known as disruptive camouflage, function through a pattern, or texture, breaking up the outline of an object. In the present embodiment, the disruptive texture pattern 126 may break up the outline of the visible expanded beads 114 on the outer surface 116 of the surfing device 110. In this embodiment of the claim, the disruptive pattern texture is in the shape of small crosses on the outer surface 116, although the skilled person will appreciate that this is a non-limiting example of a disruptive texture pattern.

In an embodiment, the texture pattern 126 may form a textured grip pattern upon a portion of the outer surface 116 of the surfing device body 112. The textured grip pattern may provide a surface enhancing the ability of a user of the surfing device to grip thereupon. In an embodiment, the textured grip pattern may be an extension of the disruptive texture pattern 126, wherein the units of the disruptive texture pattern are given increased prominence so as to also provide grip or traction to a surfer using the surfing device 110. The textured grip pattern may be in addition to or complementary to a disruptive texture pattern 126. Either or both may be present. In embodiments using either or both of a disruptive texture pattern 126 and a textured grip pattern, the pattern may be formed upon the outer surface 116 of the surfing device body 112 by sintering, moulding, thermal moulding or otherwise shaping the outer surface into the pattern.

In an embodiment, the foamed polymer beads 114 may comprise one or more colours. In some embodiments, this may enable a visible surface of the surfing device body 112 to comprise one or more colours. In an embodiment wherein there are a plurality of foamed polymer bead colours and with further reference to Inset 1A, the surfing device body 112 may comprise said plurality of colours arranged in a ‘speckled’ or ‘scattered’ pattern across at least one surface thereof. Inset C depicts an area of the outer surface 116 wherein the beads comprise a mixture of a first colour 134a, second colour 134b and third colour 134c, depicted in the inset by varying patterns. The distribution of these coloured beads 134a-c is random and done in the moulding process of the surfing device 110. In this embodiment, the multi-coloured beads 114 have randomly distributed on the periphery of the surfing device so to provide a surface finish akin to the aesthetic of terrazzo concrete, having a speckled or scattered appearance thereacross.

In an embodiment, the surfing device body 112 may be formed through discrete unit moulding, being the use of a mould to form a surfing device body 112 by injecting or otherwise inserting foamable polymer beads into the mould cavity and inducing expansion and joining of the foamable polymer beads therein. The skilled person will appreciate that discrete unit moulding is distinct from other methods of foam production, such as extrusion or batch moulding. One particular advantage of discrete moulding may lie in the ability to create a peripheral skin region 120 having a denser bead morphology than the ‘bulk’ polymer bead foam without requiring additional steps. In some embodiments, the discrete unit moulding may produce a moulded polymer bead foam blank that is at least partially shaped to form a surfing device body 112 with at least one performance enhancing component 118 embedded therein, and may incorporate the features of one or more embodiments of the invention such as a peripheral skin region 120. In such an embodiment the moulded polymer bead foam blank may subsequently be further shaped into the surfing device body without departing from the scope of the invention.

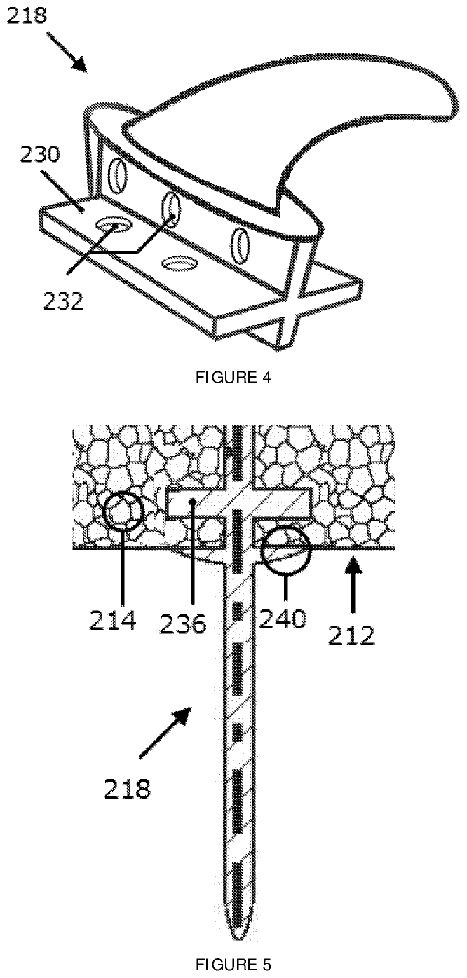

A second aspect of the present invention, and with reference to FIGS. 4 and 5, is directed to a performance enhancing component 218 for a surfing device that has a surfing device body 212 comprised of polymer bead foam 214 formed from at least one polymer selected from a single polymer class. In at least one embodiment the performance enhancing component 218 comprises an embedding portion 236 configured to be embedded into and within the surfing device body 212.

In a further embodiment, the embedding portion 236 is configured to enable the performance enhancing component to be affixed to or within the surfing device body 212 without requiring any further affixing means, such as rivets, stitching, or adhesives. The skilled person will appreciate that although FIGS. 3 and 4 depict the performance enhancing component 218 as a fin, the performance enhancing component 218 may be any type of performance enhancing component known in the art without limiting the scope of the invention.

In at least one embodiment the embedding portion 236 is formed from at least one polymer selected from the single polymer class. In a further embodiment, the performance enhancing component 218 is substantially comprised of at least one polymer selected from the single polymer class. In some embodiments, the performance enhancing component may be moulded from the at least one polymer. In a further embodiment, the performance enhancing component 218 essentially consists of the at least one polymer selected from the single polymer class in a solid and non-foamable state.

In an embodiment, the embedding portion 236 may be configured to permanently embed into the surfing device body 212. In an embodiment, the embedding portion 236 may be configured to directly bond to the surfing device body. The bonding may be through at least partial melting of a surface of the embedding portion 236 and/or bonding through the polymer bead foam melting into the performance enhancing component during the expansion process of the foamable polymer beads. The bonding may be through formation of thermal and/or molecular bonds between the embedding portion 236 and the surfing device body 212. In a further embodiment, the embedding portion 236 may comprise at least one aperture 238 extending at least partially therethrough. In such an embodiment, during formation of the surfing device body 212, a portion of material that forms into said body 212 passes into the aperture 238. As such, when the surfing device body 212 is formed and encapsulates and overmoulds onto the embedding portion 236, a portion of the surfing device body extends into the aperture 238, thereby improving contact—and subsequently, bonding—between the material of the surfing device body 212 and the embedding portion 236. In some embodiments, the aperture 238 may extend all of the way through the embedding portion 236. In other embodiments, the aperture 238 may extend partially into the structure of the embedding portion 236. Some embodiments of the performance enhancing component 218 may comprise apertures of both of the above embodiments.

In an embodiment, the performance enhancing component 218 may further comprise a contacting portion 240 that contacts against an outer surface of the surfing device body 212 and thermally bonds thereto in a manner similar to that described above.

An embodiment of the performance enhancing component 218 of the second aspect of the invention may be used in formation of a surfing device 100 of an embodiment of the first aspect. Additionally, an embodiment of the performance enhancing component 218 of the second aspect of the invention may be used in formation of a surfing device outside of the scope of the first aspect of the invention, the surfing device including a surfing device body comprised of polymer bead foam formed from polymers selected from a single polymer class, without additional affixing means between the surfing device body and the at least one performance enhancing component 218. Either arrangement is considered to fall within the scope of use of the second aspect of the invention.

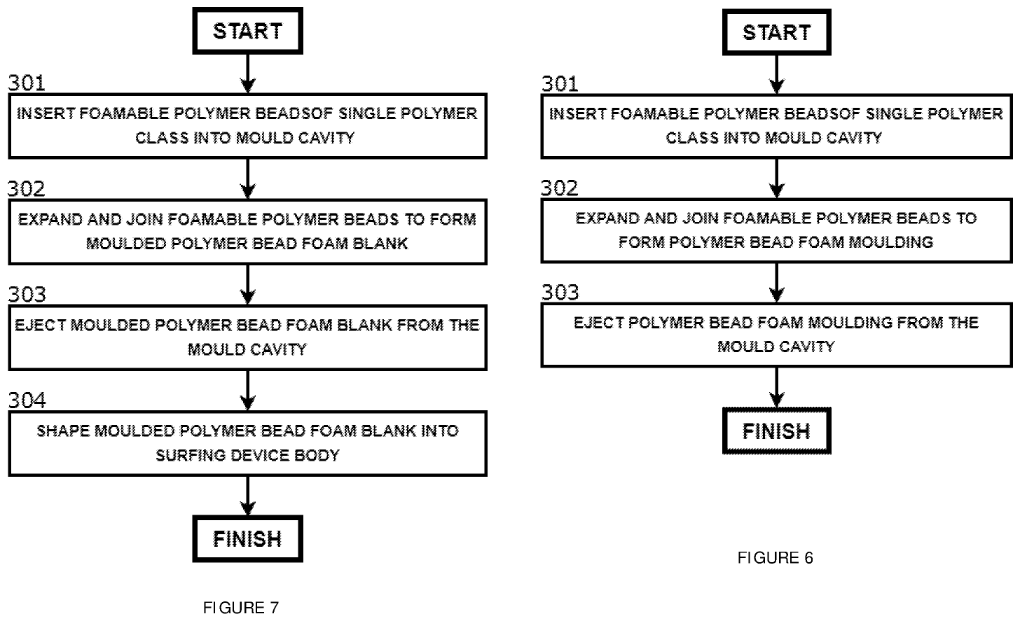

A third aspect of the invention may lie in a method of forming a surfing device body. In an embodiment and with reference to FIG. 6, the method may comprise the steps of:
301. inserting foamable polymer beads into a cavity of a mould shaped to form the surfing device body;
302. inducing expansion and joining of the foamable polymer beads within the mould cavity together into a polymer bead foam moulding; and
303. ejecting the formed polymer bead foam moulding from the mould cavity, wherein the foamable polymer beads are comprised of polymers selected from a single polymer class, being substantially identical to the single polymer class described previously. As used herein, the term “polymer bead foam moulding” refers to the product of the moulding process of an embodiment of the method of the invention. In a further embodiment, the method may form a surfing device body of an embodiment of the first aspect of the invention.

In an embodiment, the mould cavity may be shaped to substantially form the surfing device body. In a further embodiment, the mould cavity may be shaped to fully form the surfing device body, i.e. the formed polymer bead foam moulding has the desired density as well as the desired or target shape of the surfing device body and requires no further substantial processing. In a further embodiment, the method may comprise the steps of:
301. inserting foamable polymer beads into a cavity of a mould shaped to form the surfing device body;
302. inducing expansion and joining of the foamable polymer beads within the mould cavity together into a polymer bead foam moulding that matches the desired shape of the surfing device body; and
303. ejecting the formed polymer bead foam moulding from the mould cavity, the polymer bead foam moulding being substantially shaped into a surfing device body and requiring no further substantial shaping.

The skilled person will appreciate that “no further substantial processing” does not exclude typical and/or minor finishing steps applied to mouldings as known in the art. These may be steps such as such as trimming of mould flashing or sanding. Rather, “no further substantial processing” should be understood to mean that the polymer bead foam moulding is substantially shaped into the surfing device body upon completion of step 303.

In an alternate embodiment and with reference to FIG. 7, the mould cavity may be only shaped to partially form the surfing device body, i.e. the polymer bead foam moulding is formed into a moulded polymer bead foam blank, being a block of moulded polymer bead foam requiring further shaping in order to be fully shaped into a surfing device body. In such an embodiment, the method may further comprise Step 304, being the step of shaping the moulded polymer bead foam blank into a surfing device body. In an embodiment, the moulded polymer bead foam blank may comprise at least one performance enhancing component at least partially embedded therein. In a further embodiment, the method may comprise the steps of:
301. inserting foamable polymer beads into a cavity of a mould shaped to form a moulded polymer bead foam blank;
302. inducing expansion and joining of the foamable polymer beads within the mould cavity together into the moulded polymer bead foam blank;
303. ejecting the moulded polymer bead foam blank from the mould cavity; and
304. shaping the moulded polymer bead foam blank into the desired shape for a surfing device.

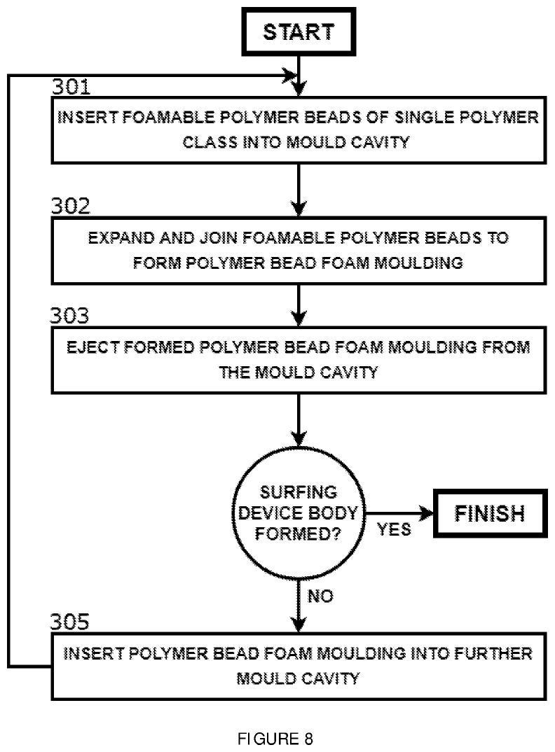

In an embodiment and with reference to FIG. 8, the method may comprise producing an initial polymer bead foam moulding, followed by the step of repeating the process so as to overmould material onto the initially-produced polymer bead foam moulding. In an embodiment, the additional step 305 may comprise:
305. if the polymer bead foam moulding is smaller in at least one dimension than the surfing device body, inserting the polymer bead foam moulding into a further mould cavity that is larger in the at least one dimension, and repeating steps 301-303, such that an additional polymer bead foam layer overmoulds onto, and thermally bonds to, the polymer bead foam moulding, forming a layered polymer bead foam moulding.

Such an embodiment may enable the formed surfing device body to have multiple layers of polymer bead foam, potentially of different densities and/or bead morphologies. This may, for example, enable the properties of stronger yet more dense polymer bead foams to be utilised without substantially increasing the overall weight of the surfing device. It may also enable or further promote formation of a stressed-shell outer layer. In a further embodiment, Steps 301-303 may be repeated more than once. In an embodiment, the polymer bead foam moulding produced through repeating steps 301-303 at least one may be a moulded polymer bead foam blank requiring further shaping through an embodiment of Step 304. The person skilled in the art will appreciate that the initially-produced polymer bead foam moulding may be the polymer bead foam moulding produced by any embodiment of the method.

In an embodiment, expansion and joining of the foamable polymer beads within the mould cavity is at least partially induced by heating of the mould cavity and/or further mould cavity and/or foamable polymer beads contained therein. Even though, in some embodiments the foamable polymer beads may already be partially foamed prior to insertion into the mould cavity in Step 301, these partially-foamed foamable polymer beads are still capable of substantial increase in volume.

In at least one embodiment, the expansion and joining process comprises heating the foamable polymer beads so as to expand and fill the mould cavity, thereby taking on the shape thereof. The heat also induces partial melting of the outer surfaces of the foamable polymer beads, allowing them to join to one another.

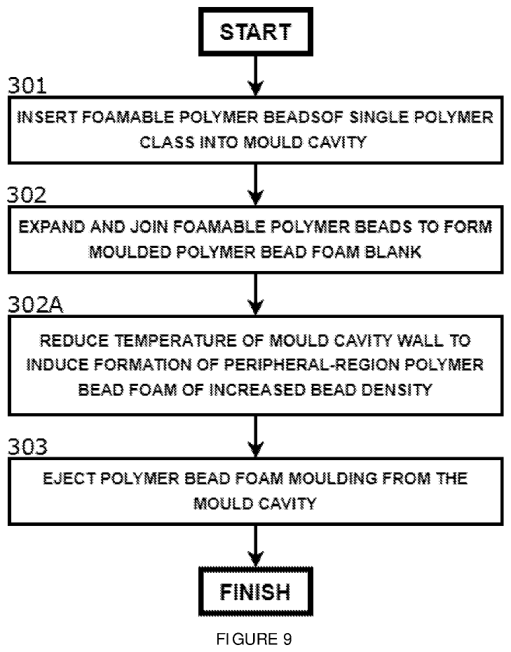

In a further embodiment and with reference to FIG. 9 the method may comprise Step 302A, comprising maintaining or reducing, a cavity wall of the mould cavity and/or further mould cavity at, or reduced to, a lower temperature than that of the mould cavity proper and/or further mould cavity proper for at least a portion of Step 302. The skilled person will appreciate that Step 302A may be executed at any point prior to completion of Step 302, including prior to Step 301, without departing from the scope of the present embodiment of the invention.

In at least one such an embodiment, the foamable polymer beads that are substantially adjacent to (or subsequently urged to be adjacent to through expansion of the bulk polymer foam beads) the cavity wall will subsequently expand to a lesser degree than the bulk foamable polymer beads further away from the cavity wall. This may form peripheral-region polymer bead foam having a denser bead or cell morphology (which is inversely proportional to the amount of local expansion induced in the polymer foam beads) than the polymer bead foam. However, the peripheral-region polymer bead foam is still integral with, and otherwise thermally bonded to, the polymer bead foam. In some embodiments, the surfing device body may transition from polymer bead foam to the peripheral-region polymer bead foam as a gradient, i.e. the expansion of polymer foam beads decreases as the beads get closer to the mould cavity wall or further mould cavity wall having a lower temperature.

In a further embodiment, the peripheral-region polymer bead foam may form into a stressed-shell structure encapsulating the rest of the polymer bead foam, such that the resulting surfing device body is a semi-monocoque having benefits and/or advantages previously identified.

In an embodiment, at least a portion of an inner surface of the mould cavity or the further mould cavity may comprise structures shaped to form at least one of a disruptive texture pattern and a textured grip pattern on an outer surface of the surfing device body during Step 302.

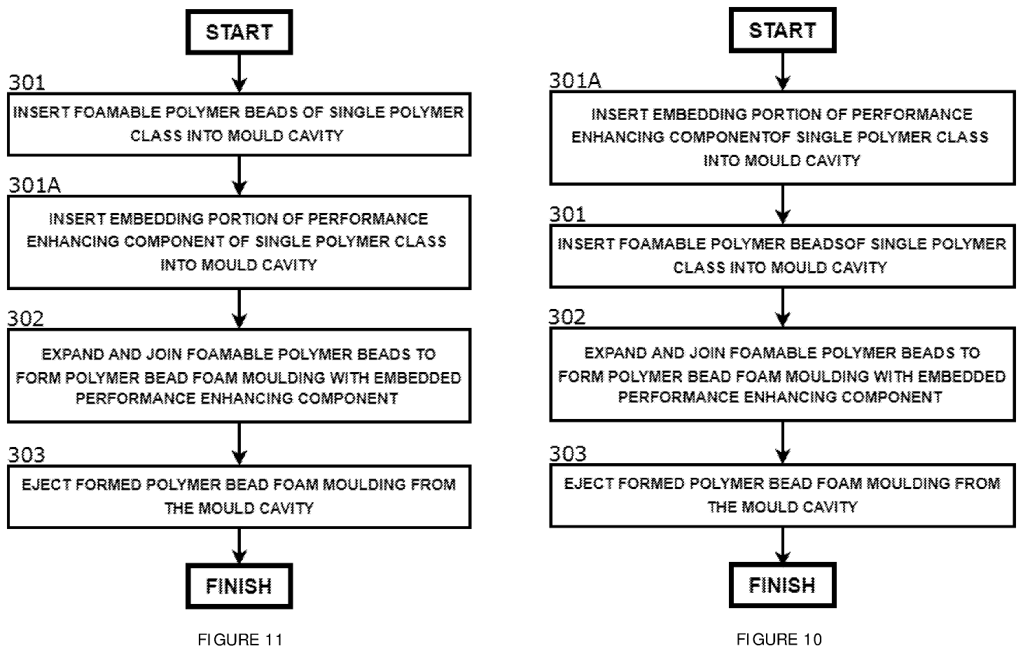

In an embodiment and with reference to FIGS. 10 & 11, the method may comprise the additional step 301A, that being inserting an embedding portion of at least one performance enhancing component, being substantially formed from polymers selected from the single polymer class in a solid and non-foamable state, into the mould cavity or further mould cavity prior to either Step 301 or Step 302. The skilled person will appreciate that in an embodiment wherein multiple layers of polymer bead foam are used (e.g. an embodiment including Step 304 being executed at least once), the embedding portion of the at least one performance enhancing component may be inserted in the initial loop. Alternatively, the embedding portion of the at least one performance enhancing component may be inserted into the further mould cavity prior to Step 301 or Step 302 of a second or later loop. In a further embodiment wherein the surfing device is to comprise multiple performance enhancing components, the embedding portions of different performance enhancing components may be inserted into the mould cavity during different loops of the method. In an embodiment, the at least one performance enhancing component is a moulded performance enhancing component. The method may comprise additional step 301A regardless of if the polymer bead foam moulding is formed into the shape of the surfing device body, into an initial polymer bead foam moulding that will have additional polymer bead foam overmoulded thereto, or into a moulding that requires further shaping to form the surfing device body.

In such an embodiment, executing Step 302, being the step of inducing expansion and joining of the foamable polymer beads, also comprises the polymer bead foam substantially encapsulating and overmoulding onto the embedding portion of the at least one performance enhancing component. In a further embodiment, the embedding portion is configured to be embedded within the surfing device body and thermally bond with the polymer bead foam of the surfing device body substantially adjacent thereto. In a further embodiment, the method may comprise using at least one performance enhancing component substantially corresponding to an embodiment of the second aspect of the invention.

In a further embodiment and with specific reference to FIGS. 3 & 10, the at least one performance enhancing component may be a pre-moulded peripheral skin. In such an embodiment, Step 301A is executed prior to Step 301.

In an embodiment, the method may comprise the additional step of affixing at least one surface-affixable performance enhancing component to an outer surface of the surfing device body, the at least one surface-affixable performance enhancing component being substantially formed from polymers selected from the single polymer class in a solid and non-foamable state. In a further embodiment, the at least one surface-affixable performance enhancing component may be affixed to the outer surface of the surfing device body by a contacting portion thereof thermally bonding to the outer surface of the surfing device body.

In an embodiment of the method including the step of embedding or affixing at least one performance enhancing component to the surfing device body, the embedding or contacting portion may be bonded to the surfing device body by at least partial melting of the embedding or contacting portion. In a further embodiment, the step of bonding the embedding or contacting portion to the surfing device body comprises the use of any one of infra-red welding, high frequency welding and ultrasonic welding. In a further embodiment, the step of bonding the embedding or contacting portion to the surfing device body induces thermal bonding therebetween. The thermal bonds may be molecular bonds extending directly between the embedding or contacting portion and the polymer bead foam the at least one performance enhancing component is embedded within or affixed to.

A fourth aspect of the invention may lie in the method of forming a surfing device body through multiple over-moulding stages, which may comprise the steps of:
401. inserting foamable polymer beads into a cavity of a mould;
402. inducing expansion and joining of the foamable polymer beads within the cavity until an initial polymer bead foam moulding forms and reaches a target density and shape;
403. ejecting the initial polymer bead foam moulding from the mould cavity;
404. inserting the initial polymer bead foam moulding into a further mould cavity that is larger in at least one dimension;
405. inserting additional foamable polymer beads into the further mould cavity and inducing expansion and joining of the additional foamable polymer beads therewithin, such that an additional polymer bead foam layer overmoulds onto, and thermally bonds to, the initial polymer bead foam moulding, forming a resulting polymer bead foam moulding;
406. ejecting the resulting polymer bead foam moulding comprising the initial polymer bead foam moulding overmoulded with the additional polymer bead foam layer, from the further mould cavity; and
407. if the resulting polymer bead foam moulding is not shaped into a surfing device body of appropriate dimensions, repeating steps 404-406 with further mould cavities that are successively larger in at least one dimension, the resulting polymer bead foam moulding formed by step 406 being the ‘initial polymer bead foam moulding’ of the subsequent step 404;

wherein the further mould cavity that shapes the resulting polymer bead foam moulding into the surfing device body of appropriate dimensions is the final further mould cavity, and the foamable polymer beads comprise polymers selected from a single polymer class.

In an embodiment, the method may further comprise the step of inserting an embedding portion of a performance enhancing component into the mould cavity prior to step 402 or into the further mould cavity prior to step 405, wherein the at least one performance enhancing component is substantially formed from polymers selected from the single polymer class in a solid and non-foamable state, and wherein the embedding portion is configured to be embedded within the surfing device body and form thermal bonds with the polymer bead foam of the surfing device body substantially adjacent thereto. In an embodiment, the method may further comprise the step of bonding the embedding portion to the surfing device body by at least partial melting of the embedding portion. In an embodiment, the step of bonding the embedding portion to the surfing device body comprises the use of any one of infra-red welding, high frequency welding and ultrasonic welding.

In an embodiment, at least a portion of an inner surface of the final further mould cavity comprises structures shaped to form at least one of a disruptive texture pattern and a textured grip pattern on an outer surface of the surfing device body during step 405.

In an embodiment, a cavity wall of the final further mould cavity is maintained at, or reduced to, a lower temperature than that of the mould cavity for at least a portion of Step 405, such that foamable polymer beads substantially adjacent to, or subsequently urged to be adjacent to, the final further mould cavity wall expand to a lesser degree than foamable polymer beads in step 402 and/or previous iterations of Step 405. This may enable the formed additional polymer bead foam layer to form into a peripheral-region polymer bead foam having a denser bead or cell morphology than that of the initial polymer bead foam being integral with, and otherwise thermally bonded to the initial polymer bead foam moulding. In a further embodiment, the final further mould cavity may be maintained at a higher temperature than that of the final cavity wall, such that the formed additional polymer layer comprises a region adjacent to the initial polymer bead foam moulding and having a foam morphology substantially similar thereto, and a peripheral region forming the peripheral-region polymer bead foam having a denser bead or cell morphology. As the skilled person will appreciate, the regions are integral with, and otherwise thermally bonded, to one another. In either embodiment, the peripheral-region polymer bead foam may form into a stressed-shell structure encapsulating the polymer bead foam, such that the resulting surfing device body is a semi-monocoque having benefits and/or advantages previously identified. In a further embodiment, the method may produce a moulded polymer bead foam blank comprising polymer bead foam with peripheral-region polymer bead foam, the moulded polymer bead foam blank then being further shaped so as to form the surfing device body, in a manner substantially similar to that described previously.

While the invention has been described with reference to preferred embodiments above, it will be appreciated by those skilled in the art that it is not limited to those embodiments, but may be embodied in many other forms, variations and modifications other than those specifically described. The invention includes all such variation and modifications. The invention also includes all of the steps, features, components and/or devices referred to or indicated in the specification, individually or collectively and any and all combinations or any two or more of the steps or features.

In this specification, unless the context clearly indicates otherwise, the word “comprising” is not intended to have the exclusive meaning of the word such as “consisting only of”, but rather has the non-exclusive meaning, in the sense of “including at least”. The same applies, with corresponding grammatical changes, to other forms of the word such as “comprise”, etc.

Other definitions for selected terms used herein may be found within the detailed description of the invention and apply throughout. Unless otherwise defined, all other scientific and technical terms used herein have the same meaning as commonly understood to one of ordinary skill in the art to which the invention belongs.

Any promises made in the present document should be understood to relate to some embodiments of the invention, and are not intended to be promises made about the invention in all embodiments. Where there are promises that are deemed to apply to all embodiments of the invention, the applicant/patentee reserves the right to later delete them from the description and they do not rely on these promises for the acceptance or subsequent grant of a patent in any country.

1. A surfing device, comprising
a surfing device body comprised of polymer bead foam being substantially formed from at least one polymer selected from a single polymer class; and
at least one performance enhancing component having a contacting portion at least partially embedded within, integral with, or affixed to a surface of, the surfing device body;
wherein the contacting portion of the at least one performance enhancing component is substantially formed from at least one polymer selected from the single polymer class in a substantially similar composition ratio.

2. The surfing device of claim 1, wherein the at least one performance enhancing component is selected from the list of peripheral skin, leash anchor, leash anchor mount, strengthening element, strengthening element mount, reinforcing fibre, fin, and fin mount.

3. The surfing device of claim 1, wherein:
the at least one performance enhancing component is a peripheral skin region, being an outer region of the polymer bead foam of the surfing device body having a denser bead morphology than an inner region of the surfing device body;
the peripheral skin is formed from, and integral with, the polymer bead foam of the surfing device body; and
the peripheral skin region forms a stressed shell structure, such that the surfing device body and integral peripheral skin region thereof is a semi-monocoque.

4. The surfing device of claim 1, wherein the contacting portion of the at least one performance enhancing component is permanently embedded into, onto, or within, or integral with, the surfing device body.

5. The surfing device of claim 1, wherein the contacting portion of the at least one performance enhancing component is directly bonded with the polymer bead foam of the surfing device body that is substantially adjacent thereto.

6. The surfing device of claim 1, wherein the surfing device does not comprise additional affixing means between the surfing device body and the at least one performance enhancing component.

7. The surfing device of claim 1, wherein the single polymer class is one of the set of classes comprising thermoplastics, recyclable thermosets, polypropylenes, polyketones, or polyolefins.

8. The surfing device of claim 1, wherein the polymer bead foam is substantially formed from a single polymer.

9. The surfing device of claim 8, wherein the at least one performance enhancing component is substantially formed from the same single polymer as the polymer bead foam of the surfing device body.

10. The surfing device of claim 8, wherein the single polymer is selected from the list of polypropylene, polyethylene, polystyrene and polyurethane.

11. The surfing device of claim 1, wherein:
the polymer bead foam is substantially formed from a first blend of polymers, each polymer in the first blend of polymers being selected from the same polymer class; and
the at least one performance enhancing component is substantially formed from a second blend of polymers, being a blend of the same selection of polymers as the first blend of polymers.

12. The surfing device of claim 11, wherein the second blend of polymers comprises the same selection of polymers, in a substantially similar compositional ratio, as the first blend of polymers.

13. The surfing device of claim 11, wherein the first blend of polymers is a blend of polyolefins.

14. (canceled)

15. The surfing device of claim 1, wherein the polymer bead foam is formed from foamable polymer beads comprising a mix of colours.

16-19. (canceled)

20. The surfing device of claim 1, wherein the embedding portion comprises at least one aperture extending therethrough, such that a portion of the surfing device body is able to protrude therethrough.

21-24. (canceled)

25. A method of forming a surfing device body having at least one moulded performance enhancing component at least partially embedded within, integral with, or affixed to a surface of, the surfing device body, the method comprising the operations of, in any suitable order:
inserting foamable polymer beads into a cavity of a mould shaped to substantially form either the surfing device body or a surfing device body blank and including at least one receiving portion;
inducing expansion and joining of the foamable polymer beads within the mould cavity together into a polymer bead foam moulding having the shape of the mould cavity;
ejecting the polymer bead foam moulding; and
embedding or contacting a contacting portion of the at least one moulded performance enhancing component with a surface of the surfing device body;
wherein the foamable polymer beads are comprised of polymers selected from a single polymer class; and
wherein the contacting portion of the at least one moulded performance enhancing component is substantially formed from polymers selected from the single polymer class.

26. (canceled)

27. The method of claim 25, wherein at least a portion of an inner surface of the mould cavity comprises structures shaped to form at least one of a disruptive texture pattern and a textured grip pattern on an outer surface of the surfing device body.

28. (canceled)

29. The method of claim 25, wherein the contacting portion of the at least one performance enhancing component thermally bonds with the polymer bead foam of the surfing device body substantially adjacent thereto.

30-31. (canceled)

32. The method of 25, further comprising the operation of bonding the contacting portion of the at least one performance enhancing component to the surfing device body by at least partial melting of the contacting portion.

33. The method of claim 32, wherein the operation of bonding the contacting portion to the surfing device body, by at least partial melting of the contacting portion, comprises the use of infra-red welding, induction welding, high frequency welding and ultrasonic welding.

34. The method of claim 25, wherein;
expansion and joining of the foamable polymer beads within the mould cavity is at least partially induced by heating of the mould cavity and/or further mould cavity and/or foamable polymer beads contained therein;
a cavity wall of the mould cavity is maintained at, or adjusted to, a temperature than different from that of the mould cavity for at least a portion of the expansion and joining operation, thereby inducing formation of peripheral-region polymer bead foam having different bead and/or cell morphology than the polymer bead foam; and
the peripheral-region polymer bead foam being integral with, and otherwise thermally bonded to, the polymer bead foam.

35. The method of claim 34, wherein the cavity wall of the mould cavity is reduced to the lower temperature prior to either the operation of inserting foamable polymer beads into the mould cavity or the operation of inducing expansion and joining thereof.

36. The method of claim 34, wherein:
the peripheral-region polymer bead foam forms into a stressed-shell structure encapsulating the polymer bead foam; and
the resulting surfing device body is a semi-monocoque.

37-56. (canceled)

57. The surfing device of claim 1, wherein the at least one performance enhancing component is at least partially shaped into a form using a moulding process.

58. The surfing device of claim 1, wherein a molecular or intermolecular bond extends between the contacting portion of the at least one performance enhancing component and the polymer bead foam of the surfing device body substantially adjacent thereto.

59. The surfing device of claim 1, wherein the surfing device body and at least one performance enhancing component are able to be recycled via a single recycling stream.

60. The method of claim 25, further comprising, in any suitable order, the operations of:
using an additional mould cavity to shape a foamable or non-foamable polymer into at least one performance enhancing component that includes at least one contacting portion that is substantially formed from the at least one polymer from the single polymer class; and
inserting an embedding portion of at least one moulded performance enhancing component into the mould cavity prior to either the operation of inserting foamable polymer beads into the mould cavity or the operation of inducing expansion and joining thereof.

61. The method of claim 25, further comprising, in any suitable order, the operations of:
placing a further mould cavity over the at least one receiving portion of the surfing device body;
using the further mould cavity to shape a foamable or non-foamable polymer into at least one performance enhancing component comprising at least one contact portion that is substantially formed from the at least one polymer from the single polymer class and that embeds onto, into, or within the at least one receiving portion of the surfing device body; and
ejecting the performance enhancing component from the further mould cavity.

62. The method of claim 25, wherein the contacting portion of the at least one performance enhancing component forms a molecular or intermolecular bond with the receiving portion of the polymer bead foam moulding of the surfing device body substantially adjacent thereto.
